(19) United States
(12) Patent Application Publication
(10) Pub. No.: US 2014/0204327 A1
(43) Pub. Date: Jul. 24, 2014

(54) DISPLAY PANEL AND MANUFACTURING METHOD THEREOF, DISPLAY DEVICE

(71) Applicant: BEIJING BOE OPTOELECTRONICS TECHNOLOGY CO., LTD., Beijing (CN)

(72) Inventors: Lingzhi CHENG, Beijing (CN); Junsheng CHEN, Beijing (CN)

(73) Assignee: BEIJING BOE OPTOELECTRONICS TECHNOLOGY CO., LTD., Beijing (CN)

(21) Appl. No.: 14/097,580

(22) Filed: Dec. 5, 2013

(30) Foreign Application Priority Data
Jan. 23, 2013 (CN) 201310024227.5

(51) Int. Cl. G02F 1/1343

(52) U.S. Cl. CPC G02F 1/1343
USPC 349/143; 438/30

(57) ABSTRACT

A display panel comprises: a first substrate and a second substrate between which a liquid crystal cell is formed; the first substrate comprises a first electrode layer provided thereon, and the second substrate comprises a second electrode layer provided thereon; the first electrode layer comprises a plurality of first electrode strips that are electrically connected, The second electrode layer comprises a plurality of second electrode strips that are electrically connected, and the first electrode strips and the second electrode strips are disposed alternately; each pair of the first electrode strip and the second electrode strip adjacent to each other are capable of generating a horizontal electric field therebetween after being applied with a voltage.

### TECHNICAL FIELD

Embodiments of the present disclosure relate to a display panel and a manufacturing method thereof, and a display device.

### BACKGROUND

Present IPS (In Plane Switch)/ADS (Advanced-Super Dimensional Switching) display panels utilize parallel alignment of liquid crystal molecules, which endows IPS/ADS display panels with excellent range of view angle. However, IPS/ADS display panels suffer problems such as high driving voltage and large power consumption.

### SUMMARY

The embodiments of the present disclosure provide a display panel and a manufacturing method thereof, and a display device which can effectively reduce the driving voltage and the power consumption of a display product while ensuring good view angle.

One aspect of the present disclosure provides a display panel comprising: a first substrate and a second substrate between which a liquid crystal cell is formed; the first substrate comprises a first electrode layer provided thereon, and the second substrate comprises a second electrode layer provided thereon; the first electrode layer comprises a plurality of first electrode strips that are electrically connected, the second electrode layer comprises a plurality of second electrode strips that are electrically connected, the first electrode strips and the second electrode strips are disposed alternately; each pair of the first electrode strip and the second electrode strip adjacent to each other are capable of generating a horizontal electric field therebetween after being applied with a voltage.

For example, sides of the first electrode strips and sides of their adjacent second electrode strips are parallel.

For example, a height of the first electrode layer is 60%-95% of a thickness of the liquid crystal cell; and a height of the second electrode layer is 60%-95% of the thickness of the liquid crystal cell. Furthermore, for example, the height of the first electrode layer is 80%-90% of a thickness of the liquid crystal cell; and the height of the second electrode layer is 80%-90% of the thickness of the liquid crystal cell.

For example, an interval between the first electrode strip and the second electrode strip adjacent to the first electrode strip is 3˜6 μm.

For example, two sides of the first electrode strips and the second electrode strips are of a flat plate shape.

Another aspect of the present disclosure provides a method for manufacturing a display panel comprising: forming a transparent conductive film on a first substrate on which a first patterned layer structure has been formed, and patterning the first transparent conductive film to form a first electrode layer with a patterning process, the first electrode layer comprising a plurality of first electrode strips that are electrically connected; forming a transparent conductive film on a second substrate on which a second patterned layer structure has been formed, and patterning the second transparent conductive film to form a second electrode layer with a patterning process, the second electrode layer comprising a plurality of second electrode strips that are electrically connected, the second electrode strips and the first electrode strips being disposed alternately; forming an alignment film on each of the first substrate with the first electrode layer formed thereon and the second substrate with the second electrode layer formed thereon; assembling the first substrate and the second substrate formed with the alignment film to form a cell and then filling liquid crystal into the cell to form a display panel.

For example, two opposite sides of each of first electrode strips may be both perpendicular to the first substrate; or two opposite sides of each of first electrode strips may be both perpendicular to the second substrate.

Yet another aspect of the present disclosure provides a display device comprising any of the above-mentioned display panels.

Further scope of applicability of the present disclosure will become apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the following detailed description.

### BRIEF DESCRIPTION OF THE DRAWINGS

The present disclosure will become more fully understood from the detailed description given hereinafter and the accompanying drawings which are given by way of illustration only, and thus are not limitative of the present disclosure and wherein:

FIG. 1 is a sectional structural schematic diagram of a display panel provided in an embodiment of the present disclosure while not being powered on;

FIG. 2 is a sectional structural schematic diagram of a display panel provided in an embodiment of the present disclosure while being powered on;

FIG. 3 is a top structural representation of a display panel provided in an embodiment of the present disclosure; and

FIG. 4 is voltage-transmittance plots of a display panel provided in an embodiment of the present disclosure and a prior art ADS display panel.

### DETAILED DESCRIPTION

The technical proposal in embodiments of the present disclosure will be clearly and completely described hereinbelow with respect to drawings in embodiments of the present disclosure. It is obvious that the described embodiments are only a part of embodiments of the present disclosure rather than all of them.

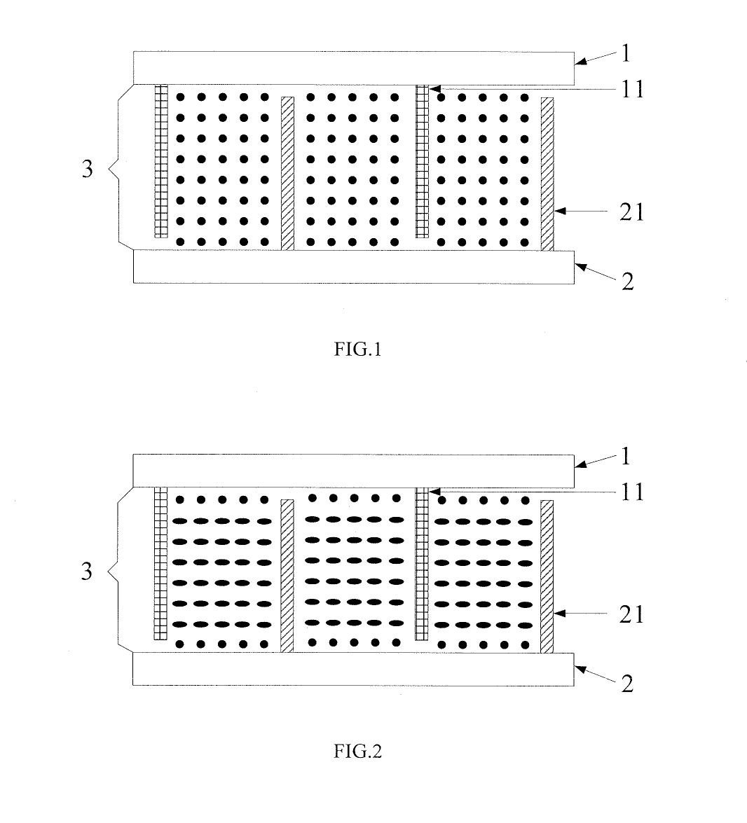

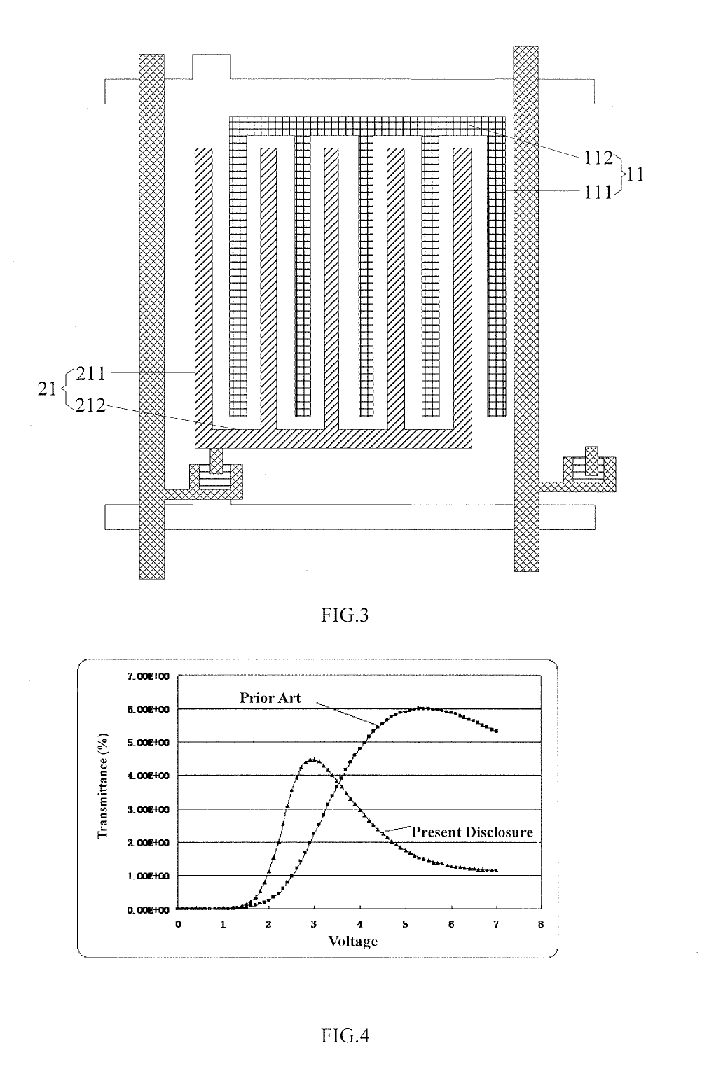

An embodiment of the present disclosure provides a display panel, and as illustrated in FIGS. 1 and 2, the display panel comprises: a first substrate 1 and a second substrate 2 disposed opposite to each other to form a liquid crystal cell 3 therebetween, and in the liquid crystal cell liquid crystal materials are filled. The first substrate 1 comprises a first electrode layer 11 provided thereon, and the second substrate 2 comprises a second electrode layer 21 provided thereon. The first electrode layer 11 comprises a plurality of first electrode strips 111 that are electrically connected, the second electrode layer 21 comprises a plurality of second electrode strips 211 that are electrically connected, and the first electrode strips 111 and the second electrode strips 211 are disposed alternately (also referring to e.g. FIG. 3).

The first electrode strips 111 and the second electrode strips 211 are projected on the corresponding substrates, and for example facing each other partially.

For example, the first substrate is a color filter substrate formed with at least a color filter and a black matrix, and the second substrate is an array substrate formed with at least a gate metal layer and a source-drain metal layer. For example, the gate metal layer comprises gate lines and gates of thin film transistors; and the source-drain metal layer comprises data lines, sources and drains of thin film transistors. Of course, the first substrate may be an array substrate while the second substrate may be a color filter substrate.

In order to ensure light transmittance of the display panel, the electrode strips (first electrode strips or second electrode strips) are transparent. In addition, in order to be different from traditional strip-like electrodes, “electrode strip” is used in the disclosure to define the shape of the electrodes in the embodiments of the present disclosure. In the embodiments of the present disclosure, an electrode strip is of a shape with a certain length, a certain width and a certain height with respect to the corresponding substrate, and a side face for measuring the length and height of an “electrode strip” is called “side”.

For example, the first electrode strips 111 and second electrode strips 21 may have heights of 60%-95% of the thickness (cell gap) of the liquid crystal cell 3. The effect is optimal when the heights of the first electrodes 11 and the second electrodes 21 are 80%-90% of the thickness of the liquid crystal cell 3. In the embodiments of the present disclosure, two opposite sides of each of the first or second electrode strips are perpendicular to the corresponding substrate, for example, may be of a flat plate shape, such that a horizontal electric field can be generated between each pair of the first electrode strips and the second electrode strips adjacent to each other when a voltage is applied therebetween (being powered on).

In general, the width of an “electrode strip” is small with respect to its length and height, and may be uniform, and of course may be not uniform. However in the embodiments of the present disclosure, preferably, two sides of each electrode strip (first electrode strip or second electrode strip) are parallel, that is, the width of an electrode strip may be uniform.

Further preferably, sides of the first electrode strip 111 are parallel to sides of its adjacent second electrode strip 211. This contributes to forming of a uniform horizontal electric field.

In addition, it is noted that parts for electrically connecting electrode strips may be of an arbitrary shape such as along column shape, and a strip pattern with a negligible height, as long as this part can serve for electric connection. As illustrated in FIG. 3, the first electrode layer 11 comprises first electrode strips 111 and a first connecting section 112 for electrically connecting the first electrode strips 111. The second electrode layer 21 comprises second electrode strips 211 and a second connecting section 212 for electrically connecting individual second electrode strips 211. The embodiments of the present disclosure impose no limitations on the shape of first connecting sections 112 and second connecting sections 212.

In the embodiments of the present disclosure, there is no specific limitation on the spacing distance between the first electrode strip 111 and the second electrode strip 211 that are adjacent to each other in one pair. The driving voltage increases as the distance increases. When the first electrode strip 111 is spaced apart from its adjacent second electrode strip 211 by 3˜6 μm, both the transmittance and the driving voltage of the display panel may be good.

As illustrated in FIG. 1, the first electrode strips 111 and the second electrode strips 211 are alternately disposed and the liquid crystal within the liquid crystal cell 3 is horizontally aligned. After a driving voltage is applied across the first electrode strips 111 and the second electrode strips 211, the first electrode strips 111 and the second electrode strips 211 form a horizontal electric field and bring about capacitance. Since electric field lines of this horizontal electric field hardly bend in areas where liquid crystal exists, as illustrated in FIG. 2, after being powered on, liquid crystal in the liquid crystal cell 3 is almost rotated horizontally while no rotation is in the vertical direction. In a conventional ADS or IPS display panel, it is inevitable that liquid crystal rotate in the vertical direction in the areas far away from electrodes because in these areas electric field lines are bent. Therefore the display panel provided in the embodiments of the present disclosure has a large range of view angle than conventional ADS and IPS display panels.

The display panel provided in the embodiments of the present disclosure features low driving voltage, short response time and can effectively reduce power consumption and shorten response time. FIG. 4 shows voltage-transmittance curves of a structure of one embodiment of the present disclosure and a present traditional structure. As can be seen in FIG. 4, the structure in the embodiment of the present disclosure can realize maximum transmittance at a voltage of 2.9V, and the present traditional structure can only realize maximum transmittance at a voltage of 5.4 V and its transmittance at 2.9V is only 44% of that of the display panel provided in the embodiment of the present disclosure. In addition, since the electrodes provided in the embodiment of the present disclosure are of a long column shape, after being powered on, the liquid crystal between the first electrode strips and the second electrode strips can be deflect rapidly in the horizontal direction, resulting in short response time.

An embodiment of the present disclosure further provides a method for manufacturing a display panel, and the method comprises the following process, taking the display panel as illustrated in FIG. 1 or 2 as an example.

Step 1. A transparent conducting film is manufactured on a first substrate 1 having formed thereon a first patterned layer structure, and a first electrode layer 11 is formed by patterning the transparent conducting film; the first electrode layer 11 comprises a plurality of first electrode strips that are electrically connected 111. For example, two opposite sides of the first electrode strips 111 may be both perpendicular to the first substrate 1, and for example, may be of a flat plate shape.

Step 2. A transparent conducting film is manufactured on a second substrate 2 having formed thereon a second patterned layer structure and a second electrode layer 21 is formed by patterning the transparent conducting film; the second electrode layer 21 comprises a plurality of second electrode strips that are electrically connected 211; the first electrode strips 111 and the second electrode strips 211 are disposed alternately. For example, two opposite sides of the second electrode strips 211 may be both perpendicular to the second substrate 2, and for example, may be of a flat plate shape.

Here, “patterned layer structure” is used to describe one or more layers of structures with various patterns formed on a transparent substrate. Generally there are two kinds of the patterned layer structures. One example is the structure in which at least a color filter pattern and a black matrix pattern are formed on a color filter substrate. The other example is the structure in which at least a gate metal layer pattern and a source-drain metal layer pattern are formed on an array substrate. For example, the gate metal layer pattern comprises patterns of gate lines and gates of thin film transistors; and the source-drain metal layer pattern comprises patterns of data lines, sources and drains of thin film transistors. In an embodiment of the present disclosure, the first substrate may be a color filter substrate, the second substrate may be an array substrate, or the first substrate may be an array substrate and the second substrate may be a color filter substrate.

Step 3. A photosensitive aligning material layer is formed on the first substrate 1 on which a first electrode layer 11 is formed and the second substrate 2 on which a second electrode layer 21 is formed, and an alignment film is formed by ultraviolet irradiation.

Step 4. The first substrate 1 formed with the alignment film and the second substrate 2 are assembled to form a cell and then filled with liquid crystal into the cell to form a display panel.

In the method for manufacturing a display panel provided in embodiments of the present disclosure, the first electrode strips and the second electrode strips are disposed alternately by disposing a first electrode layer containing a plurality of first electrode strips that are electrically connected and a second electrode layer containing a plurality of second electrode strips that are electrically connected. Since electrodes are designed as e.g., a long column structure with sides of a flat plate shape, both electrodes are area electrodes while being powered on. This allows a horizontal electric field to be generated between adjacent first electrode strips and second electrode strips, which in turn ensure the liquid crystal display device has an excellent view angle under action of the horizontal electric field and can effectively reduce driving voltages and power consumption of the display product at the same time.

An embodiment of the present disclosure further provides a display device comprising any of the above-mentioned display panels. The display device may be any product or component with display function such as a liquid crystal display, a liquid crystal TV, a digital camera, a mobile phone, a tablet computer, or the like.

What have been described above are only specific implementations of the present disclosure, the protection scope of the present disclosure is not limited thereto. Any changes or substitutions easily occur to those skilled in the art within the technical scope of the present disclosure should be covered in the protection scope of the present disclosure. Therefore, the protection scope of the present disclosure should be based on the protection scope of the claims.

What is claimed is:

1. A display panel comprising: a first substrate and a second substrate between which a liquid crystal cell is formed;
wherein the first substrate comprises a first electrode layer provided thereon, and the second substrate comprises a second electrode layer provided thereon; the first electrode layer comprises a plurality of first electrode strips that are electrically connected,
the second electrode layer comprises a plurality of second electrode strips that are electrically connected, the first electrode strips and the second electrode strips are disposed alternately; each pair of the first electrode strip and the second electrode strip adjacent to each other are capable of generating a horizontal electric field therebetween after being applied with a voltage.

2. The display panel of claim 1, wherein two sides of the first electrode strips and the second electrode strips are parallel.

3. The display panel of claim 1, wherein the first electrode layer and the second electrode layer are formed of a transparent material.

4. The display panel of claim 1, wherein sides of the first electrode strip and sides of the second electrode strip adjacent to the first electrode strip are parallel.

5. The display panel of claim 1, wherein a height of the first electrode layer is 60%-95% of a thickness of the liquid crystal cell; and a height of the second electrode layer is 60%-95% of the thickness of the liquid crystal cell.

6. The display panel of claim 5, wherein the height of the first electrode layer is 80%-90% of a thickness of the liquid crystal cell; and the height of the second electrode layer is 80%-90% of the thickness of the liquid crystal cell.

7. The display panel of claim 1, wherein an interval between the first electrode strip and the second electrode strip adjacent to the first electrode strip is 3˜6 μm.

8. The display panel of claim 1, wherein two sides of the first electrode strips and the second electrode strips are of a flat plate shape.

9. A method for manufacturing a display panel comprising:
forming a transparent conductive film on a first substrate on which a first patterned layer structure has been formed, and patterning the first transparent conductive film to form a first electrode layer with a patterning process, wherein the first electrode layer comprises a plurality of first electrode strips that are electrically connected;
forming a transparent conductive film on a second substrate on which a second patterned layer structure has been formed, and patterning the second transparent conductive film to form a second electrode layer with a patterning process, wherein the second electrode layer comprises a plurality of second electrode strips that are electrically connected, and the second electrode strips and the first electrode strips are disposed alternately;
forming an alignment film each of the first substrate with the first electrode layer formed thereon and the second substrate with the second electrode layer formed thereon; and
assembling the first substrate and the second substrate each formed with the alignment film to form a cell and then filling liquid crystal into the cell to form a display panel.

10. The method of claim 9, wherein sides of the first electrode strips and the second electrode strips are of a flat plate shape.

11. The method of claim 9, further comprising forming a photosensitive aligning material layer on each of the first electrode layer and the second electrode layer and forming an alignment film with ultraviolet irradiation.

12. The method of claim 9, wherein two opposite sides of each of the first electrode strips are both perpendicular to the second substrate.

13. The method of claim 12, wherein two opposite sides of each of the second electrode strips are both perpendicular to the second substrate.

14. A display device comprising a display panel of claim 1.
